(19) United States
(12) Patent Application Publication
(10) Pub. No.: US 2016/0230809 A1
(43) Pub. Date: Aug. 11, 2016

(54) TIERED AXIAL BEARING WITH S-SHAPED INTERMEDIATE WASHER

(71) Applicant: Schaeffler Technologies AG & Co. KG, Herzogenaurach (DE)

(72) Inventors: Dennis Roffe, Fort Mill, SC (US); James Kevin Brown, Rock Hill, SC (US); Joseph T. Griffin, Matthews, NC (US)

(73) Assignee: Schaeffler Technologies AG & Co. KG, Herzogenaurach (DE)

(21) Appl. No.: 14/619,544

(22) Filed: Feb. 11, 2015

(51) Int. Cl. F16C 19/30; F16C 19/48; F16C 33/58; F16C 33/30; F16C 43/04; F16C 43/06

(52) U.S. Cl. CPC F16C 19/305; F16C 43/04; F16C 43/065; F16C 33/58; F16C 33/30; F16C 19/48

(57) ABSTRACT

An axial bearing assembly is provided having first and second axial end washers with axial flanges. An intermediate washer is provided with first and second axial retention flanges extending opposite radial ends. The first axial retention flange extends toward the first axial end washer on the other radial side from the first axial flange, and the second axial retention flange extends toward the second axial end washer on the other radial side from the second axial flange to define an S-shaped cross-section. Roller assemblies including rolling elements retained in cages are located between the first and second bearing inner races and outer races, respectively. Retention tabs are formed in the first and second axial retention flanges that engage over a part of the first cage and over a part of the second cage, respectively, to retain the first and second bearing roller assemblies to the intermediate washer.

### FIELD OF INVENTION

This application is generally related to rolling bearings and more particularly, to axial rolling bearing arrangements to improve axial load ratings and speed capability.

### BACKGROUND

In some applications, two axial roller bearings are stacked one on top of the other in order to increase the axial load rating and speed capability for a particular support application. Additionally, the diameters of the two axial roller bearings can be different in order to accommodate different radial sizes of axial surfaces being supported. These bearings typically have flat washer-shaped rings with axial flanges for rolling element retention, with a number of rolling elements located between the washer-shaped rings. However, such arrangements use additional space and are typically limited with respect to the widths available.

It would therefore be desirable to provide a multi-level axial bearing with reduced space and more flexibility with respect to size while avoiding the drawbacks of the known prior art.

### SUMMARY

In one embodiment, an axial bearing assembly is provided having a first axial end washer having a first radial body defining a first bearing outer race, and a first axial flange on one of a radially inner or outer side, and a second axial end washer having a second radial body defining a second bearing outer race, and a second axial flange on the other of the radially inner or outer side from the first axial flange, and the first and second axial flanges facing in an axial direction toward one another. An intermediate washer is provided with an intermediate radial body with first and second axial sides, the first axial side defining a first bearing inner race and the second axial side defining a second bearing inner race, and first and second axial retention flanges extending from the radial inner and outer ends of the intermediate radial body. The first axial retention flange extends toward the first axial end washer on the other of the radially inner or outer side from the first axial flange, and the second axial retention flange extends toward the second axial end washer on the other of the radially inner or outer side from the second axial flange such that the intermediate radial body and the first and second axial retention flanges define an S-shaped cross-section. A first bearing roller assembly including a first plurality of rolling elements retained in a first cage is located between the first bearing inner race and the first bearing outer race. A second bearing roller assembly including a second plurality of rolling elements retained in a second cage is located between the second bearing inner race and the second bearing outer race. A plurality of retention tabs are formed in the first and second axial retention flanges that engage over a part of the first cage and over a part of the second cage, respectively, to retain the first and second bearing roller assemblies to the intermediate washer. Preferably, outer retention tabs are located on the first and second axial flanges that engage over a part of the first cage and over a part of the second cage, respectively, to retain the first and second axial end washers to the assembly. This results in a more compact, preassembled dual axial bearing that can provide for higher load ratings and increased speed capabilities within a smaller envelope than two separate bearings. Additionally, installation is considerably easier due to the axial bearing assembly with two bearings being retained together.

In another aspect, the retention tabs are integrally formed in the intermediate washer, and the outer retention tabs are integrally formed in the first and second axial end washers.

Preferably, the retention tabs are pre-formed in the intermediate washer first and second axial retention flanges, and snap over the cages of the first and second roller bearing assemblies during assembly.

In one preferred arrangement, the first and second pluralities of rolling elements comprise needle rollers.

In one embodiment, the first bearing roller assembly has a different diameter than the second bearing roller assembly. The sizes of the first and second axial end washers and the intermediate washer are adjusted accordingly. However, the roller bearing assemblies could also have the same dimensions.

The first cage and the second cage are preferably made from a metallic or polymeric material.

Preferably, the first axial end washer, the second axial end washer, and the intermediate washer are each formed as an integral stamped sheet metal part. The sheet metal is preferably bearing grade sheet, and after stamping, the parts are preferably de-burred and/or polished in a vibratory process, hardened, and tempered.

In another aspect, a method of assembling a dual axial roller bearing is provided, comprising:

forming a first axial end washer having a first radial body defining a first bearing outer race, and a first axial flange on one of a radially inner or outer side;

forming a second axial end washer having a second radial body defining a second bearing outer race, and a second axial flange on the other of the radially inner or outer side from the first axial flange, and the first and second axial flanges facing in an axial direction toward one another;

forming an intermediate washer having an intermediate radial body with first and second axial sides, the first axial side defining a first bearing inner race and the second axial side defining a second bearing inner race, first and second axial retention flanges extending from the radial inner and outer ends of the intermediate radial body, the first axial retention flange extending toward the first axial end washer on the other of the radially inner or outer side from the first axial flange, and the second axial retention flange extending toward the second axial end washer on the other of the radially inner or outer side from the second axial flange such that the intermediate radial body and the first and second axial retention flanges define an S-shaped cross-section, with a plurality of retention tabs being formed in the first and second axial retention flanges;

assembling a first bearing roller assembly by inserting a first plurality of rolling elements into a first cage, and positioning the first bearing roller assembly between the first bearing inner race and the first bearing outer race by snapping the first cage under the retention tabs of the first axial retention flange; and

assembling a second bearing roller assembly by inserting a second plurality of rolling elements into a second cage, and positioning the second bearing roller assembly between the second bearing inner race and the second bearing outer race by snapping the second cage under the retention tabs of the second axial retention flange.

In a further preferred aspect, the method further includes forming outer retention tabs on the first and second axial flanges that engage over a part of the first cage and over a part of the second cage, respectively, and snapping the first cage under the outer retention tabs of the first axial flange and snapping the second cage under the outer retention tabs of the second axial flange to retain the first and second axial end washers to the assembly.

In another aspect, the method preferably includes stamping each of the first axial end washer, the second axial end washer, and the intermediate washer as an integral part from sheet metal.

Additional preferred arrangements of the bearing assembly having one or more features of the invention are described below and in the claims.

### BRIEF DESCRIPTION OF THE DRAWINGS

The foregoing Summary as well as the following Detailed Description will be best understood when read in conjunction with the appended drawings. In the drawings:

FIG. 1 is a plan view of a tiered axial bearing with an S-shaped intermediate washer.

FIG. 2 is a cross-sectional view taken along line 2-2 in FIG. 1.

FIG. 3 is a partial perspective view, partly in cross-section, of the bearing assembly of FIG. 1.

FIG. 4 is a perspective view of the bearing assembly of FIG. 1.

FIG. 5 is an exploded perspective view of bearing assembly of FIG. 1.

### DETAILED DESCRIPTION OF THE PREFERRED EMBODIMENTS

Certain terminology is used in the following description for convenience only and is not limiting. The words “inner,” “outer,” “inwardly,” and “outwardly” refer to directions towards and away from the parts referenced in the drawings. A reference to a list of items that are cited as “at least one of a, b, or c” (where a, b, and c represent the items being listed) means any single one of the items a, b, c or combinations thereof. The terminology includes the words specifically noted above, derivatives thereof, and words of similar import.

Referring to the Figures, an axial bearing assembly 10 is shown. The axial bearing assembly 10 includes a first axial end washer 12, shown in detail in FIGS. 2 and 5, having a first radial body 14 defining a first bearing outer race. A first axial flange 18 extends on one of a radially inner or outer side of the first axial end washer 12. In the embodiment shown, the flange 18 extends from the radially inner side.

Still with reference to FIGS. 2, 3, and 5, a second axial end washer 22 is provided having a second radial body 24 defining a second bearing outer race 26. A second axial flange 28 extends from the second radial body 24 on the other of the radially inner or outer side from the first axial flange 18. As shown in detail in FIG. 2, in this case, the second axial flange 28 extends from the radially outer side. However, those skilled in the art will recognize from the present disclosure that the positions of the first and second axial flanges could be switched. The first and second axial flanges 18, 28 face toward one another in an axial direction of the axial bearing assembly 10.

Referring to FIGS. 2 and 5, an intermediate washer 32 having an intermediate radial body 34 with first and second axial sides 36, 38 is provided. The first axial side 36 defines a first inner bearing race 40 and the second axial side 38 defines a second bearing inner race 42. First and second axial retention flanges 44, 46 extend from the radially inner and outer sides of the intermediate radial body 34. The first axial retention flange 44 extends toward the first axial end washer 12 on the other of the radially inner or outer side from the first axial flange 18. In the illustrated embodiment, this means that the first axial retention flange 44 extends from the radially outer side of the intermediate radial body 34. The second axial retention flange 46 extends toward the second axial end washer 22 on the other of the radially inner or outer side from the second axial flange 28. In this case, the second axial retention flange 46 is located on the radially inner side of the intermediate radial body 34. Here, based on the opposite extension directions and positions of the first and second axial retention flanges 44, 46 on the intermediate radial body 34, it defines an S-shaped cross-section shown clearly in FIG. 2.

Still with references to FIGS. 2-5, a first bearing roller assembly 50 including a first plurality of rolling elements 52 retained in a first cage 54 is located between the first bearing inner race 40 and the first bearing outer race 16. A second bearing roller assembly 60 which includes a second plurality of rolling elements 62 retained in a cage 64 is located between the second bearing inner race 42 and the second bearing outer race 26. As shown in detail in FIGS. 2-5, a plurality of retention tabs 48 are formed in the first and second axial retention flanges 44, 46 that engage over a part of the first cage 54 and over a part of the second cage 64, respectively, to retain the first and second bearing roller assemblies 50, 60, to the intermediate washer 32.

Additionally, preferably the first and second axial flanges 18, 28 include outer retention tabs 30 that engage over a part of the first cage 54 and over a part of the second cage 64, respectively, to retain the first and second axial washers 12, 22 to the assembly 10, as shown in FIGS. 2, 4, and 5.

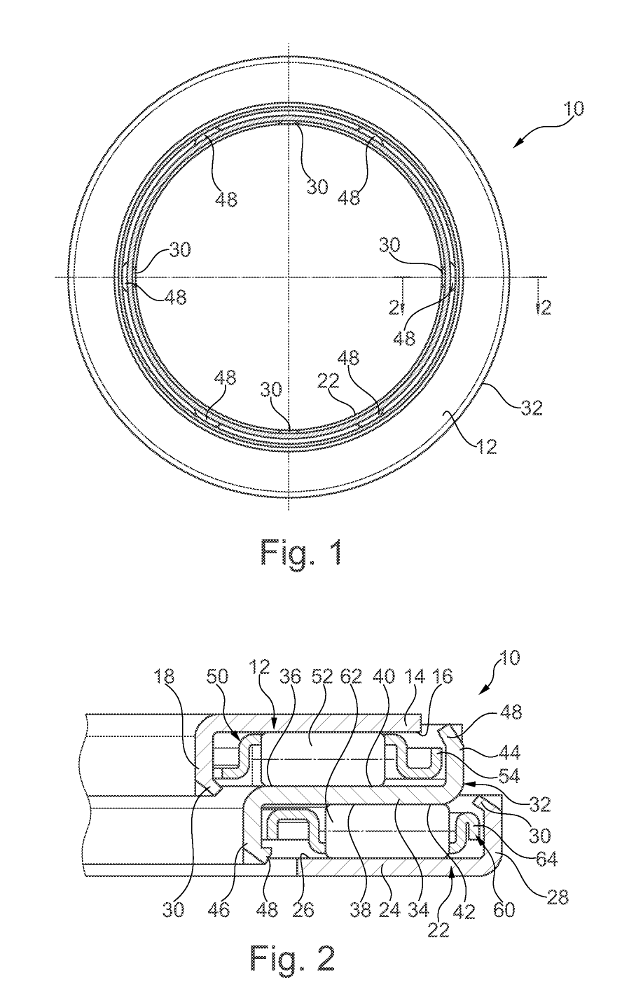

As shown in FIGS. 1, 4, and 5, the retention tabs 48 on the intermediate washer 32 are preferably equally circumferentially spaced about the inner and outer peripheries on the retention flanges 44, 46. They are preferably at least two of the retention tabs 48 on the first axial retention flange 44 and at least two of the retention tabs 48 on the second axial retention flange 46. Preferably, there are at least four equally circumferentially spaced retention tabs on each of the first and second axial retention flanges 44, 46. However, the number of retention tabs 48 can be varied depending on the bearing size and application.

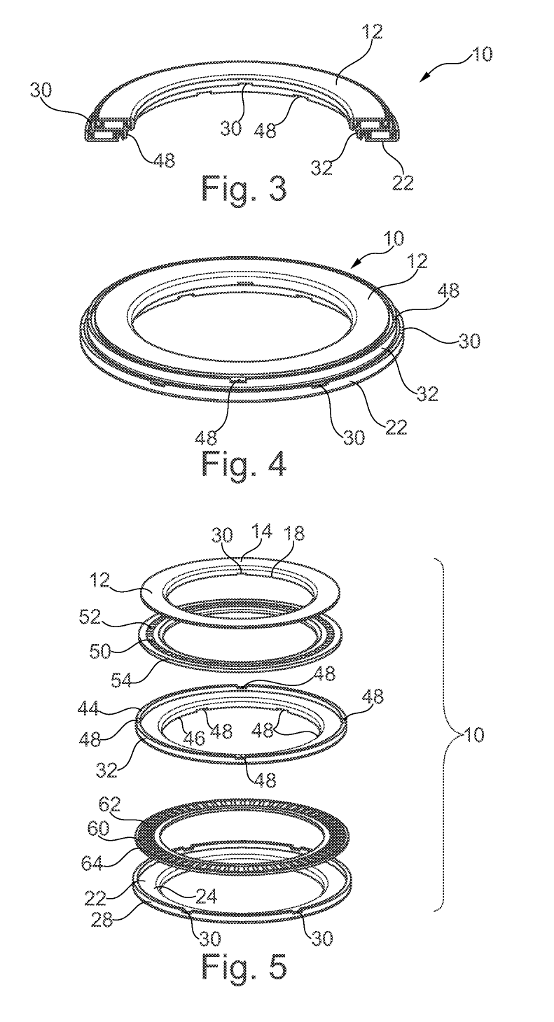

With respect to the outer retention tabs 30, preferably, as shown in FIGS. 3 and 5, there are at least two and more preferably 4 of the outer retention tabs 30 located on the first axial flange 18, and these are preferably equally circumferentially spaced apart. With respect to the second axial flange 28, this preferably includes at least two and preferably four or more of the outer retention tabs 30 that are also equally spaced apart in the circumferential direction.

The retention tabs 48 are preferably integrally formed in the first and second axial retention flanges 44, 46 of the intermediate washer 32 and the outer retention tabs 30 are preferably integrally formed in the first and second axial flanges 18, 28 of the first and second axial end washers 12, 22, respectively.

Preferably, the retention tabs 48 snap over the cages 54, 56 of the first and second roller bearing assemblies 50, 60 during assembly. This can be achieved due to the flexibility provided by the cages 54, 64 in being sufficiently compliant so that the retention tabs can snap thereover and retain the first and second roller bearing assemblies 50, 60 in position against the intermediate washer 32 so that the axial bearing assembly 10 can be pre-assembled. Preferably, the same type of fit is provided for the first and second end washers 12, 22, with the cages 54, 64 of the first and second roller bearing assemblies 50, 60, being sufficiently compliant in order to allow the outer retention tabs located on the first and second axial flanges 18, 28 of the first and second axial end washers 12, 22 to snap over the first and second cages 54, 64, respectively. This allows the entire unit to be pre-assembled with first and second axial end washers 12, 22, the intermediate washer 32, and the first and second bearing roller assemblies 50, 60, providing a smaller envelope than would previously be available using two separate axial roller bearings while providing the same capacity for axial load as well as speed capability.

Depending upon the desired configuration, the first bearing roller assembly 50 has a different diameter than the second roller bearing assembly 60, as shown in FIGS. 1 and 2. This allows for a tiered assembly as shown in FIG. 2. It is also possible for the first and second bearing roller assemblies 50, 60 to be the same diameter. Further, it is also within the scope of the invention to provide two or more intermediate washers between the first and second axial end washers 12, 22 with possibly third or additional bearing roller assemblies located therebetween to provide a pre-assembled axial bearing assembly retained together as one unit having three or more bearing roller assemblies located therein.

In the preferred embodiment shown, the first and second plurality of rolling elements 52, 62 comprise needle rollers. Preferably, the first cage and second cage 54, 64 are made from a metallic or polymeric material. Thus, the cages 54, 64 can be made from stamped sheet metal or injection molded polymeric materials, depending upon the particular application.

Preferably, the first axial end washer 12, the second axial end washer 22, and the intermediate washer 32 are each formed as an integral stamped sheet metal part. These parts are typically stamped from a bearing grade steel sheet metal, subjected to a vibratory cleaning and/or deburring, prior to being hardened and tempered. Additional processing, such as polishing of the raceways can also be provided, depending upon the particular application and surface finish desired.

A method of assembling a dual axial roller bearing 10 is also provided which includes forming the first axial end washer 12, the second axial end washer 22 as well as the intermediate washer 32 as described above. A plurality of the retention tabs 48 are formed in the first and second axial retention flanges 18, 28. The first bearing roller assembly and second bearing roller assembly 50, 60 are assembled. The first bearing roller assembly 50 is positioned between the first bearing inner race 40 and the first bearing outer race 16 and is snapped in position by snapping the first cage 54 under the retention tabs 48 of the first axial retention flange 44. The second roller bearing assembly 60 is also positioned between the second bearing inner race 42 and the second bearing outer race 26 by snapping the second cage 64 under the retention tabs 48 of the second axial retention flange 46. Preferably, the first and second axial end washers 12, 22 are also engaged by the outer retention tabs 30 formed on the first and second axial flanges 18, 28 being snapped over the first cage, with the first cage moving under the outer retention tabs 30 of the first axial flange 18 and by snapping the second cage 64 under the outer retention tabs 30 of the second axial flange 28 to retain the first and second axial end washers 12, 22 to the bearing assembly 10.

As a result of the assembly, a more compact, pre-assembled axial bearing assembly 10 is provided, which can have a tiered configuration depending upon the diameters of the first bearing roller assembly 50 and the second bearing roller assembly 60 and the use of correspondingly sized first and second axial end washers 12, 22.

Having thus described various embodiments of the present axial bearing assembly in detail, it is to be appreciated and will be apparent to those skilled in the art that many physical changes, only a few of which are exemplified in the detailed description above, could be made in the assembly without altering the inventive concepts and principles embodied therein. The present embodiments are therefore to be considered in all respects as illustrative and not restrictive, the scope of the invention being indicated by the appended claims rather than by the foregoing description, and all changes which come within the meaning and range of equivalency of the claims are therefore to be embraced therein.

What is claimed is:

1. An axial bearing assembly, comprising:
a first axial end washer having a first radial body defining a first bearing outer race, and a first axial flange on one of a radially inner or outer side;
a second axial end washer having a second radial body defining a second bearing outer race, and a second axial flange extends from second radial body on the other of the radially inner or outer side from the first axial flange, and the first and second axial flanges facing in an axial direction toward one another;
an intermediate washer having an intermediate radial body with first and second axial sides, the first axial side defining a first bearing inner race and the second axial side defining a second bearing inner race, first and second axial retention flanges extending from the radial inner and outer ends of the intermediate radial body, the first axial retention flange extending toward the first axial end washer on the other of the radially inner or outer side from the first axial flange, and the second axial retention flange extending toward the second axial end washer on the other of the radially inner or outer side from the second axial flange such that the intermediate radial body and the first and second axial retention flanges define an S-shaped cross-section;
a first bearing roller assembly including a first plurality of rolling elements retained in a first cage located between the first bearing inner race and the first bearing outer race;
a second bearing roller assembly including a second plurality of rolling elements retained in a second cage located between the second bearing inner race and the second bearing outer race;
a plurality of retention tabs formed in the first and second axial retention flanges that engage over a part of the first cage and over a part of the second cage, respectively, to retain the first and second bearing roller assemblies to the intermediate washer.

2. The axial bearing assembly of claim 1, further comprising outer retention tabs located on the first and second axial flanges that engage over a part of the first cage and over a part of the second cage, respectively, to retain the first and second axial end washers to the assembly.

3. The axial bearing assembly of claim 2, wherein the retention tabs are integrally formed in the intermediate washer, and the outer retention tabs are integrally formed in the first and second axial end washers.

4. The axial bearing assembly of claim 1, wherein the retention tabs are pre-formed in the intermediate washer first and second axial retention flanges, and snap over the cages of the first and second roller bearing assemblies during assembly.

5. The axial bearing assembly of claim 1, wherein the first and second pluralities of rolling elements comprise needle rollers.

6. The axial bearing assembly of claim 1, wherein the first bearing roller assembly has a different diameter than the second bearing roller assembly.

7. The axial bearing assembly of claim 1, wherein the first cage and the second cage are made from a metallic or polymeric material.

8. The axial bearing assembly of claim 1, wherein the first axial end washer, the second axial end washer, and the intermediate washer are each formed as an integral stamped sheet metal part.

9. A method of assembling a dual axial roller bearing, comprising:
forming a first axial end washer having a first radial body defining a first bearing outer race, and a first axial flange on one of a radially inner or outer side;
forming a second axial end washer having a second radial body defining a second bearing outer race, and a second axial flange extends from second radial body on the other of the radially inner or outer side from the first axial flange, and the first and second axial flanges facing in an axial direction toward one another;
forming an intermediate washer having an intermediate radial body with first and second axial sides, the first axial side defining a first bearing inner race and the second axial side defining a second bearing inner race, first and second axial retention flanges extending from the radial inner and outer ends of the intermediate radial body, the first axial retention flange extending toward the first axial end washer on the other of the radially inner or outer side from the first axial flange, and the second axial retention flange extending toward the second axial end washer on the other of the radially inner or outer side from the second axial flange such that the intermediate radial body and the first and second axial retention flanges define an S-shaped cross-section, with a plurality of retention tabs being formed in the first and second axial retention flanges;
assembling a first bearing roller assembly by inserting a first plurality of rolling elements into a first cage, and positioning the first bearing roller between the first bearing inner race and the first bearing outer race by snapping the first cage under the retention tabs of the first axial retention flange; and
assembling a second bearing roller assembly by inserting a second plurality of rolling elements into a second cage, and positioning the second bearing roller assembly between the second bearing inner race and the second bearing outer race by snapping the second cage under the retention tabs of the second axial retention flange.

10. The method of claim 9, further comprising:
forming outer retention tabs on the first and second axial flanges that engage over a part of the first cage and over a part of the second cage, respectively, and snapping the first cage under the outer retention tabs of the first axial flange and snapping the second cage under the outer retention tabs of the second axial flange to retain the first and second axial end washers to the assembly.

11. The method of claim 10, wherein the retention tabs are integrally formed in the intermediate washer, and the outer retention tabs are integrally formed in the first and second axial end washers.

12. The method of claim 9, further comprising:
stamping each of the first axial end washer, the second axial end washer, and the intermediate washer as an integral part from sheet metal.

13. The method of claim 9, wherein the first and second pluralities of rolling elements comprise needle rollers.

14. The method of claim 9, wherein the first bearing roller assembly has a different diameter than the second bearing roller assembly.

15. The method of claim 9, wherein the first cage and the second cage are made from a metallic or polymeric material.
